(19) United States
(12) Patent Application Publication
(10) Pub. No.: US 2026/0343593 A1
(43) Pub. Date: Oct. 29, 2026

(54) ACCESS POINT

(71) Applicant: NTT, Inc., Tokyo (JP)

(72) Inventors: Akira KISHIDA, Musashino-shi (JP); Kengo NAGATA, Musashino-shi (JP); Yusuke ASAI, Musashino-shi (JP); Yasushi TAKATORI, Musashino-shi (JP)

(73) Assignee: NTT, Inc., Tokyo (JP)

(21) Appl. No.: 19/099,050

(22) PCT Filed: Aug. 10, 2022
(86) PCT No.: PCT/JP2022/030555

§ 371 Date: Jan. 28, 2025

(51) Int. Cl. H04W 74/04

(52) U.S. Cl. CPC H04W 74/04

(57) ABSTRACT

An access point includes a transmission part. The transmission part transmits an RTS signal including an RTS frame to a terminal immediately after start of a service period or immediately after exchanging data frames performed during the service period, and transmits a trigger signal including a trigger frame to a terminal which has received the RTS frame immediately after receiving the CTS frame from the terminal which has received the RTS frame.

### TECHNICAL FIELD

Embodiments relate to an access point.

### BACKGROUND ART

A wireless local area network (LAN) is known as a system for wirelessly connecting an access point (AP) and a terminal. A wireless LAN allows terminals located within the communication range of an AP to access the network via the AP. APs and terminals may provide service periods for preferentially exchanging low-latency traffic in some cases. A function which provides such a service period is called a restricted TWT (r-TWT) function.

### CITATION LIST

### Non Patent Literature

NPL 1: IEEE P802.11beTM/D1.5, “35.9 Restricted TWT (r-TWT)”, Mar. 18, 2022

### SUMMARY OF INVENTION

### Technical Problem

Some terminals do not support an r-TWT function. In order to enable preferential exchange of low-latency traffic even when there are terminals which do not support the r-TWT function, setting a transmission suppression period using a quiet interval for the terminals which do not support the r-TWT function) is also being considered. However, the time length of the quiet interval set together with the service period is determined to be a predetermined time shorter than the service period. Although a plurality of transmission suppression periods may be set during a service period, the transmission suppression period set by the quiet period does not cover the entire service period. For this reason, at the end of a certain transmission suppression period or the like, there is a possibility that an interruption in transmission by another terminal which does not exchange low-latency traffic may occur.

An embodiment has been made with attention to the above circumstances and an object of the embodiment is to provide a wireless communication environment in which low-latency traffic can be exchanged preferentially even when there are terminals that do not support the r-TWT function.

### Solution to Problem

An access point according to an aspect includes a transmission part. The transmission part transmits an RTS signal including an RTS frame to a terminal immediately after start of a service period or immediately after exchanging data frames performed during the service period, and transmits a trigger signal including a trigger frame to a terminal which has received the RTS frame immediately after receiving the CTS frame from the terminal which has received the RTS frame.

### Advantageous Effects of Invention

According to an embodiment, it is possible to provide a wireless communication environment in which low latency traffic can be exchanged preferentially even when there is a terminal which does not support the r-TWT function.

### BRIEF DESCRIPTION OF DRAWINGS

FIG. 1 is a block diagram showing an example of a configuration of a communication system according to an embodiment.

FIG. 2 is a block diagram showing an example of a hardware configuration of an AP according to the embodiment.

FIG. 3 is a block diagram showing an example of a hardware configuration of a terminal according to the embodiment.

FIG. 4 is a block diagram showing an example of a functional configuration of the AP according to the embodiment.

FIG. 5A is a diagram showing a first example of a format of a beacon frame according to the embodiment.

FIG. 5B is a diagram showing a second example of the format of the beacon frame according to the embodiment.

FIG. 6 is a diagram showing an example of a format of a trigger frame.

FIG. 7 is a block diagram showing an example of a functional configuration of the terminal according to the embodiment.

FIG. 8 is a block diagram showing an example of a functional configuration relating to transmission determination processing of the terminal according to the embodiment.

FIG. 9 is a flowchart for describing an example of an operation of the AP according to the embodiment.

FIG. 10 is a flowchart for describing an operation of the terminal according to the embodiment.

FIG. 11 is a diagram showing an example of an operation during a service period r-TWT-SP using a system according to the embodiment.

### DESCRIPTION OF EMBODIMENTS

Embodiments will be explained below with reference to the drawings. Note that, in the following description, constituent elements having the same function and configuration are denoted by the same reference numerals.

### Embodiments

### 1. Configuration

A configuration of a communication system according to an embodiment will be explained.

### 1.1 Communication System

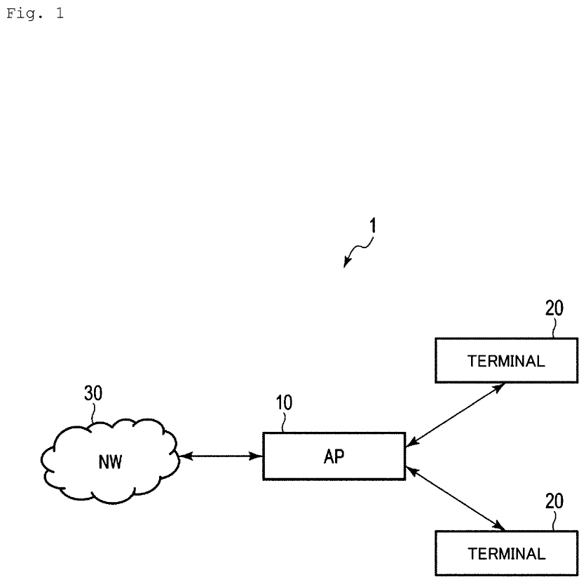

FIG. 1 is a block diagram showing an example of a configuration of a communication system according to an

As shown in FIG. 1, a communication system 1 includes an access point (AP) 10, terminals 20, and a network 30.

The AP 10 is, for example, a wireless LAN base station. The AP 10 is configured to communicate with a server (not shown) on the network 30 in a wired or wireless manner. The AP 10 is configured to communicate with the terminals 20 in a wireless manner. Communication between the AP 10 and the terminals 20 complies with, for example, the IEEE 802.11 standard.

The terminals 20 are, for example, wireless terminals such as a smartphone or a personal computer (PC). The terminals 20 are configured to communicate with a server on the network 30 via the AP 10. In FIG. 1, two of the terminals 20 are shown. The number of terminals 20 included in the communication system 1 may be one or three or more.

The AP 10 and the terminal 20 have, for example, a wireless communication function based on an open systems interconnection (OSI) reference model. In the OSI reference model, the wireless communication function has 7 layers (first layer: physical layer, second layer: data link layer, third layer: network layer, fourth layer: transport layer, fifth layer: session layer, sixth layer: presentation layer, seventh layer: application layer). The data link layer includes a logical link control (LLC) sub-layer and a media access control (MAC) sub-layer.

The AP 10 has an r-TWT function to ensure an opportunity to exchange traffic that requires low latency. By using the r-TWT function, the AP 10 can set a service period in which the exchange of traffic which requires low latency can be prioritized over the exchange of traffic which does not require low latency. Such a service period is also called r-TWT-SP (Service Period). On the other hand, the terminal 20 may or may not support the r-TWT function. For example, when two or more of the terminals 20 exist, only some of the terminals 20 may support the r-TWT function. Here, the terminals 20 which do not support the r-TWT function are terminals which do not support the r-TWT functionality because they are old standard terminals which cannot understand messages relating to r-TWT include terminals which do not support the r-TWT function, which are standard terminals which can understand messages relating to r-TWT.

### 1.2 Hardware Configurations

Hardware configurations of the AP and the terminals in the communication system according to the embodiment will be explained below.

### 1.2.1 AP Hardware Configuration

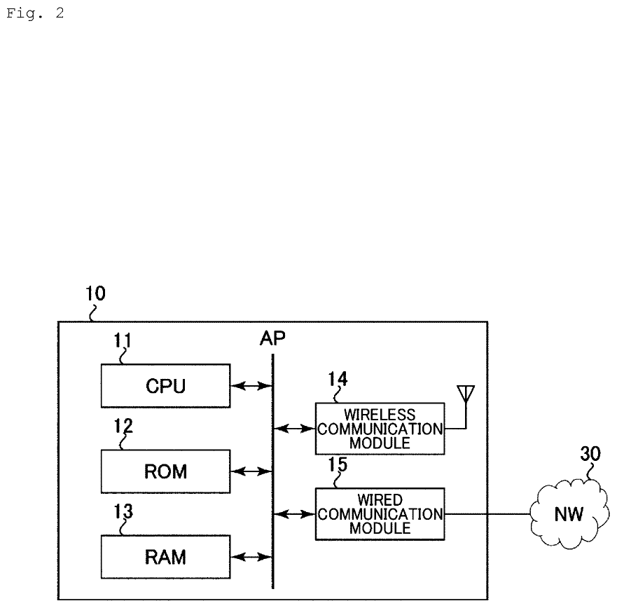

FIG. 2 is a block diagram showing an example of a hardware configuration of the AP according to the embodiment. As shown in FIG. 2, the AP 10 includes, for example, a central processing unit (CPU) 11, a read only memory (ROM) 12, a random access memory (RAM) 13, a wireless communication module 14, and a wired communication module 15.

The CPU 11 is a processing circuit which controls the overall operation of the AP 10. The ROM 12 is, for example, a non-volatile semiconductor memory. The ROM 12 stores programs and data for controlling the AP10. The RAM 13 is, for example, a volatile semiconductor memory. The RAM 13 is used as a work area for the CPU 11. The wireless communication module 14 is a circuit used for transmitting and receiving data using wireless signals. The wireless communication module 14 is connected to the antenna. The wired communication module 15 is a circuit used for transmitting and receiving data using wired signals. The wired communication module 15 is connected to the network 30.

### 1.2.2 Terminal Hardware Configuration

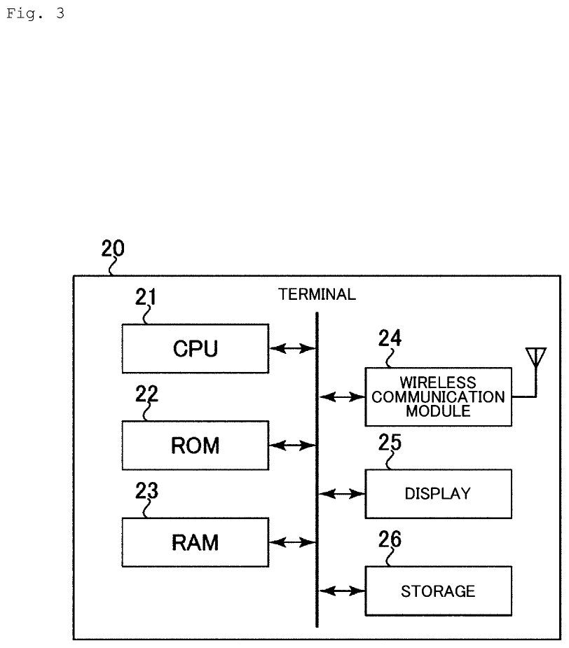

FIG. 3 is a block diagram showing an example of a hardware configuration of the terminal according to the embodiment. As shown in FIG. 3, the terminal 20 includes, for example, a CPU 21, a ROM 22, a RAM 23, a wireless communication module 24, a display 25, and a storage 26.

The CPU 21 is a processing circuit which controls the overall operation of the terminal 20. The ROM 22 is, for example, a non-volatile semiconductor memory. The ROM 22 stores programs and data for controlling the terminal 20. The RAM 23 is, for example, a volatile semiconductor memory. The RAM 23 is used as a work area for the CPU 21. The wireless communication module 24 is a circuit used for transmitting and receiving data using wireless signals. The wireless communication module 24 is connected to the antenna. The display 25 is, for example, a liquid crystal display (LCD) or an electro-Luminescence (EL) display. The display 25 displays a graphical user interface (GUI) or the like corresponding to application software. The storage 26 is a non-volatile storage device. The storage 26 stores system software of the terminal 20 and the like.

### 1.3 Functional Configuration

Functional configurations of the AP and the terminal in the communication system according to the embodiment will be explained below.

### 1.3.1 AP Functional Configuration

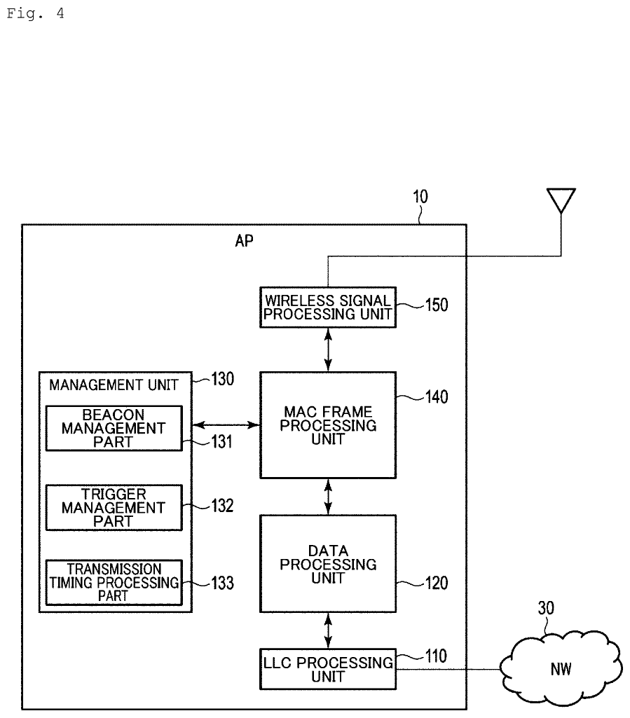

FIG. 4 is a block diagram showing an example of a functional configuration of the AP according to the embodiment. The AP 10 functions as a computer including an LLC processing unit 110, a data processing unit 120, a management unit 130, a MAC frame processing unit 140, and a wireless signal processing unit 150. The LLC processing unit 110 is a functional block which performs processing corresponding to the LLC sub-layer of the second layer and the third to seventh layers. The data processing unit 120, the management unit 130, and the MAC frame processing unit 140 are functional blocks which perform processing corresponding to the MAC sub-layer of the second layer. The wireless signal processing unit 150 is a functional block which performs processing corresponding to the MAC sub-layer of the second layer and the first layer.

The LLC processing unit 110 generates an LLC packet by adding, for example, a destination service access point (DSAP) header, a source service access point (SSAP) header, or the like to the data received from the network 30. Also, the LLC processing unit 110 inputs the generated LLC packet to the data processing unit 120. In addition, the LLC processing unit 110 extracts data from the LLC packet input from the data processing unit 120. Furthermore, the LLC processing unit 110 transmits the extracted data to the network 30.

The data processing unit 120 adds a MAC header to the LLC packet input from the LLC processing unit 110 to generate a MAC frame. Also, the data processing unit 120 inputs the generated MAC frame to the MAC frame processing unit 140. Furthermore, the data processing unit 120 extracts LLC packets from the MAC frame input from the MAC frame processing unit 140. In addition, the data processing unit 120 inputs the extracted LLC packet to the LLC processing unit 110. In the following, MAC frames including data are also referred to as “data frames.”

The management unit 130 manages communication between the AP 10 and the terminal 20. For example, the management unit 130 sets up r-TWT when low-latency traffic is scheduled to be exchanged. In the r-TWT setup, the management unit 130 sets a service period r-TWT-SP for the terminal 20 which supports the r-TWT function. Furthermore, the management unit 130 is configured so that, during the service period r-TWT-SP, traffic exchange using the terminal 20 which is scheduled to exchange low-latency traffic is performed with priority over traffic exchange using the terminal 20 which is not scheduled to exchange low-latency traffic. Various MAC frames are input and output between the management unit 130 and the MAC frame processing unit 140. The management unit 130 includes a beacon management part 131, a trigger management part 132, and a transmission timing processing part 133.

The beacon management part 131 manages information transmitted by the AP 10 as a beacon signal. Specifically, the beacon management part 131 generates a beacon frame which includes r-TWT management information relating to the r-TWT function. Also, the beacon management part 131 inputs the generated beacon frame to the MAC frame processing unit 140.

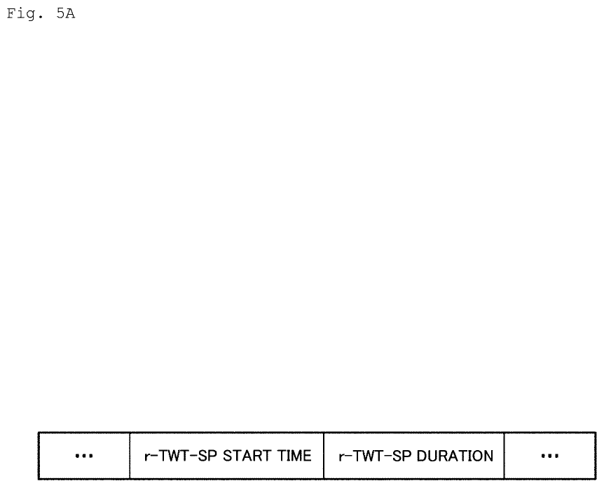

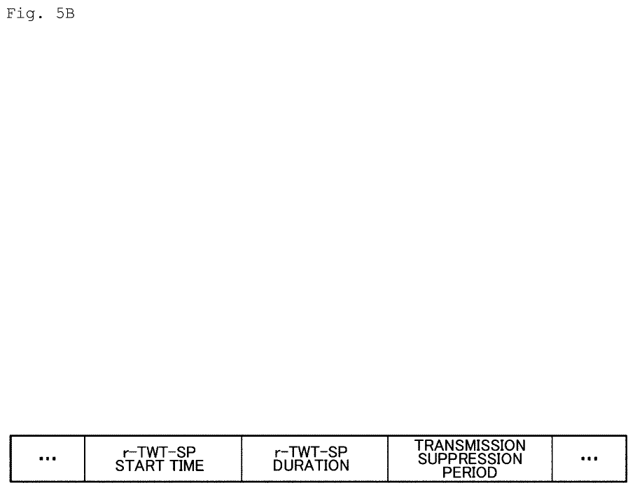

FIG. 5A is a diagram showing a first example of the format of the beacon frame according to the embodiment. As shown in FIG. 5A, the beacon frame of the first example includes, for example, an r-TWT-SP start time and an r-TWT-SP duration as r-TWT management information used in the r-TWT function.

The r-TWT-SP start time is information indicating a time at which the service period r-TWT-SP starts. The r-TWT-SP duration is information indicating a length of the service period r-TWT-SP. That is to say, the service period r-TWT-SP is set as the period from the r-TWT-SP start time to the time at which the r-TWT-SP duration has elapsed.

The terminal 20 supporting the r-TWT function can recognize the service period r-TWT-SP using the r-TWT-SP start time and the r-TWT-SP duration included in the beacon frame. On the other hand, the terminal 20 which does not support the r-TWT function ignores it depending on the r-TWT-SP start time and the r-TWT-SP duration included in the beacon frame irrespective of whether the service period r-TWT-SP cannot be recognized or can be recognized.

FIG. 5B is a diagram showing a second example of the format of the beacon frame according to the embodiment. As shown in FIG. 5B, the beacon frame of the second example includes, for example, a transmission suppression period in addition to the r-TWT-SP start time and the r-TWT-SP duration as r-TWT management information used in the r-TWT function.

The transmission suppression period is a period during which transmission of data frames is suppressed. The transmission suppression period can be set using, for example, a quiet interval defined in the IEEE 802.11 standard. A time length of the quiet interval as the transmission suppression period is, for example, 1 time unit (TU). Furthermore, the transmission suppression period is set to overlap with the service period. Specifically, the start time of the transmission suppression period is set to be the same as the r-TWT-SP start time. A plurality of transmission suppression periods may be set during r-TWT-SP. A terminal 20 which does not support the r-TWT function can also recognize the transmission suppression period. On the other hand, even when the terminal 20 which supports the r-TWT function receives the notification of the transmission suppression period during which it and the service period overlap, it behaves as when there was no notification.

Here, the transmission suppression period may be transmitted to the terminal 20 using a MAC frame such as a trigger frame which is different from the beacon frame.

The trigger management part 132 manages a trigger frame transmitted to the terminal 20. In the embodiment, before generating the trigger frame; the trigger management part 132 generates a Request to Send (RTS) frame addressed to the terminal 20 whose service period is scheduled. Also, the trigger management part 132 generates a trigger frame for causing the terminal 20 which has transmitted the CTS frame to acquire the transmission right on the basis of the Clear to Send (CTS) frame returning from the terminal 20 in response to the RTS frame.

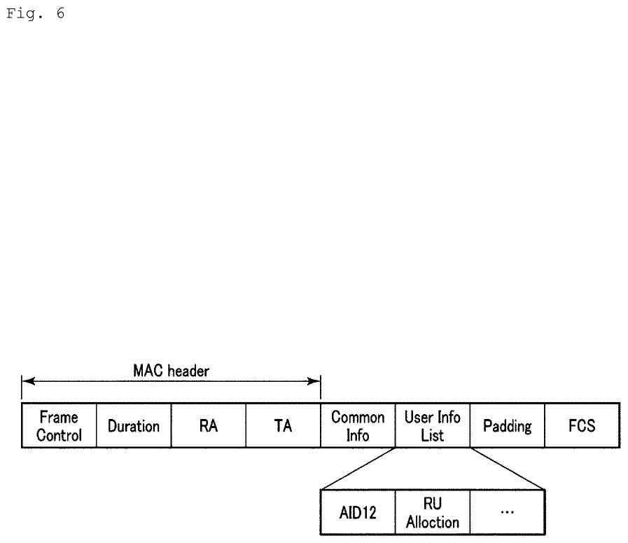

FIG. 6 is a diagram showing an example of a format of a trigger frame. As shown in FIG. 6, a MAC header of the trigger frame includes a Frame Control field, a Duration field, an RA (Receiving STA address) field, a TA (Transmitting STA address) field, a Common Info field, and a User Info List field. The Frame Control field is a field for storing various control information such as information indicating the frame type. The Duration field is a field for storing the scheduled period for using the wireless line. The RA field is a field for storing the MAC address of the receiving station. The TA field is a field for storing the MAC address of the transmitting station. The Common Info field is a field for storing common information in the subordinate terminals 20. The User Info List field is a field for storing information relating to a specific terminal 20. The User Info List field in the embodiment includes, for example, an association identifier (AID) 12 subfield and a resource unit (RU) Allocation subfield. The AID 12 subfield is a subfield for storing a terminal identifier (AID) which specifies the terminal 20 to which resources are allocated using the RU Allocation subfield. The RU Allocation subfield is a subfield for storing information about resource allocation to the terminal 20 specified using the AID 12 subfield. The resources include things such as the frequency (channel) used by the corresponding terminal 20, a transmission start timing, and a transmission period. Note that subfields other than the AID 12 subfield and RU Allocation which constitute the User Info List may be determined as appropriate.

Referring to FIG. 4 again, the functional configuration of the AP 10 will be explained. The transmission timing processing part 133 determines the transmission timing of the RTS frame and the trigger frame from the trigger management part 132. Specifically, the transmission timing processing part 133 sets a priority for each of the terminals 20 and determines the transmission timing of the RTS frame and the trigger frame in the order of the set priority. The priority of the terminals 20 may be determined, for example, in accordance with the priority of traffic in which each of the terminals 20 attempts to exchange. For example, a high priority is set for each of the terminals 20 which require low-latency traffic exchange. When there are a plurality of terminals 20 which require low-latency traffic exchange, a higher priority is set for the terminals 20 with the shortest tolerable delay.

When the MAC frame is input from the data processing unit 120 or the management unit 130, the MAC frame processing unit 140 inputs the input MAC frame to the wireless signal processing unit 150. Furthermore, when a MAC frame is input from the wireless signal processing unit 150, the MAC frame processing unit 140 inputs the MAC frame to the data processing unit 120 or the management unit 130 depending on the type of the MAC frame. Specifically, the MAC frame processing unit 140 inputs the MAC frame to the data processing unit 120 when the MAC frame is a data frame. The MAC frame processing unit 140 inputs the MAC frame to the management unit 130 when the MAC frame is a management frame or a control frame.

The wireless signal processing unit 150 adds a preamble and the like to the MAC frame input from the MAC frame processing unit 140 to generate a wireless frame. The wireless signal processing unit 150 converts the generated wireless frame into a wireless signal. Also, the wireless signal processing unit 150 radiates (transmits) the converted wireless signal via the antenna. The conversion process from a wireless frame to a wireless signal includes, for example, convolutional encoding processing, interleaving processing, sub-carrier modulation processing, inverse fast Fourier transform processing, orthogonal frequency division multiplexing (OFDM) modulation processing, and frequency conversion processing. Furthermore, the wireless signal processing unit 150 converts a wireless signal received from the terminal 20 via the antenna into a wireless frame. The conversion process from a wireless signal to a wireless frame includes, for example, frequency conversion processing, OFDM demodulation processing, fast Fourier transform processing, sub-carrier demodulation processing, deinterleaving processing, and Viterbi decoding processing. The wireless signal processing unit 150 extracts the MAC frame from the converted wireless frame. Also, the wireless signal processing unit 150 inputs the extracted MAC frame to the MAC frame processing unit 140.

Furthermore, the wireless signal processing unit 150 performs transmission determination processing to determine whether a data frame can be transmitted at the time of transmitting a wireless frame. The transmission determination processing will be explained later.

### 1.3.2 Terminal Functional Configuration

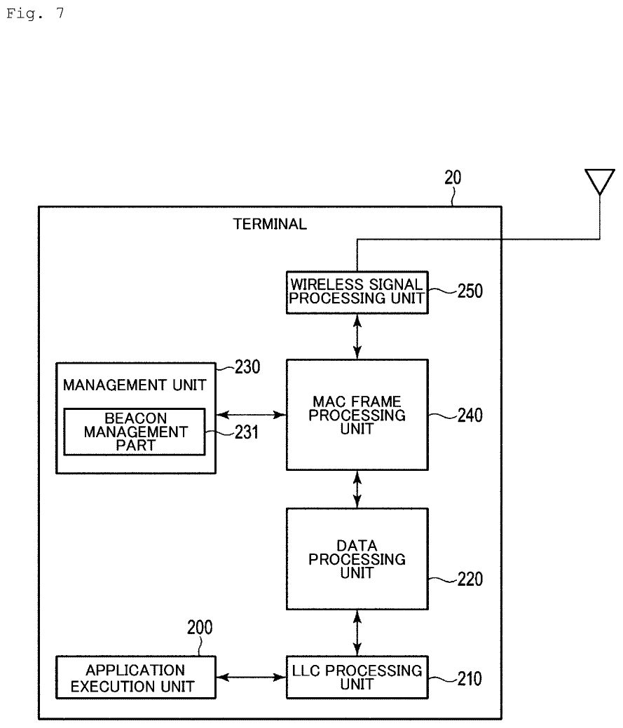

FIG. 7 is a block diagram showing an example of a functional configuration of a terminal according to the embodiment. The terminal 20 functions as a computer including an application execution unit 200, an LLC processing unit 210, a data processing unit 220, a management part 230, a MAC frame processing unit 240, and a wireless signal processing unit 250. The application execution unit 200 is a functional block which performs processing corresponding to the seventh layer. The LLC processing unit 210 is a functional block which performs processing corresponding to the LLC sub-layer of the second layer and the third to sixth layers. The data processing unit 220, the management part 230, and the MAC frame processing unit 240 are functional blocks which perform processing corresponding to the MAC sub-layer of the second layer. The wireless signal processing unit 250 is a functional block which performs processing corresponding to the MAC sub-layer of the second layer and the first layer.

The application execution unit 200 performs an application on the basis of data input from the LLC processing unit 210. Furthermore, the application execution unit 200 inputs data to the LLC processing unit 210. For example, the application execution unit 200 can display application information on the display 25. Furthermore, the application execution unit 200 can operate on the basis of the operation of the input interface.

The LLC processing unit 210 adds a DSAP header, an SSAP header, or the like to the data input from the application execution unit 200 and generates an LLC packet. Also, the LLC processing unit 210 inputs the generated LLC packet to the data processing unit 220. In addition, the LLC processing unit 210 extracts data from the LLC packet input from the data processing unit 220. Also, the LLC processing unit 210 inputs the extracted data to the application execution unit 200.

The data processing unit 220 adds a MAC header to the LLC packet input from the LLC processing unit 210 to generate a MAC frame. Furthermore, the data processing unit 220 inputs the generated MAC frame to the MAC frame processing unit 240. Furthermore, the data processing unit 220 extracts LLC packets from the MAC frame input from the MAC frame processing unit 240. In addition, the data processing unit 220 inputs the extracted LLC packet to the LLC processing unit 210.

The management part 230 manages communication between the AP 10 and the terminals 20. Various MAC frames are input and output between the management part 230 and the MAC frame processing unit 240. The management part 230 includes a beacon management part 231.

The beacon management part 231 manages information included in the beacon signal received from the AP 10. Specifically, the beacon management part 231 extracts management information relating to the r-TWT function from the beacon frame input from the MAC frame processing unit 240 and holds the extracted management information. For example, the beacon management part 231 of the terminal 20 which supports the r-TWT function extracts the r-TWT-SP start time and the r-TWT-SP duration as management information relating to the r-TWT function. Furthermore, for example, the beacon management part 231 of the terminal 20 which supports the r-TWT function and the terminal 20 which does not support the r-TWT function extracts the transmission suppression period as management information relating to the r-TWT function.

When the MAC frame is input from the data processing unit 220 or the management part 230, the MAC frame processing unit 240 inputs the input MAC frame to the wireless signal processing unit 250. Furthermore, when a MAC frame is input from the wireless signal processing unit 250, the MAC frame processing unit 240 inputs the MAC frame to the data processing unit 220 or the management part 230 depending on the type of the MAC frame. Specifically, the MAC frame processing unit 240 inputs the MAC frame to the data processing unit 220 when the MAC frame is a data frame. The MAC frame processing unit 240 inputs the MAC frame to the management part 230 when the MAC frame is a management frame or a control frame.

The wireless signal processing unit 250 adds a preamble and the like to the MAC frame input from the MAC frame processing unit 240 to generate a wireless frame. The wireless signal processing unit 250 converts the generated wireless frame into a wireless signal. Also, the wireless signal processing unit 250 radiates (transmits) the converted wireless signal via the antenna. The conversion process from a wireless frame to a wireless signal includes, for example, convolutional encoding processing, interleaving processing, sub-carrier modulation processing, inverse fast Fourier transform processing, OFDM modulation processing, and frequency conversion processing. Furthermore, the wireless signal processing unit 250 converts the wireless signal received from the AP 10 via the antenna into a wireless frame. The conversion process from a wireless signal to a wireless frame includes, for example, frequency conversion processing, OFDM demodulation processing, fast Fourier transform processing, sub-carrier demodulation processing, deinterleaving processing, and Viterbi decoding processing. The wireless signal processing unit 250 extracts the MAC frame from the converted wireless frame. Also, the wireless signal processing unit 250 inputs the extracted MAC frame to the MAC frame processing unit 240.

Furthermore, the wireless signal processing unit 250 performs transmission determination processing to determine whether a data frame can be transmitted at the time of transmitting a wireless frame. The transmission determination processing will be explained later.

### 1.3.3 Functional Configuration Relating to Transmission Determination Processing

Functional configurations relating to transmission determination processing of each of the AP 10 and the terminals 20 according to the embodiment will be explained below.

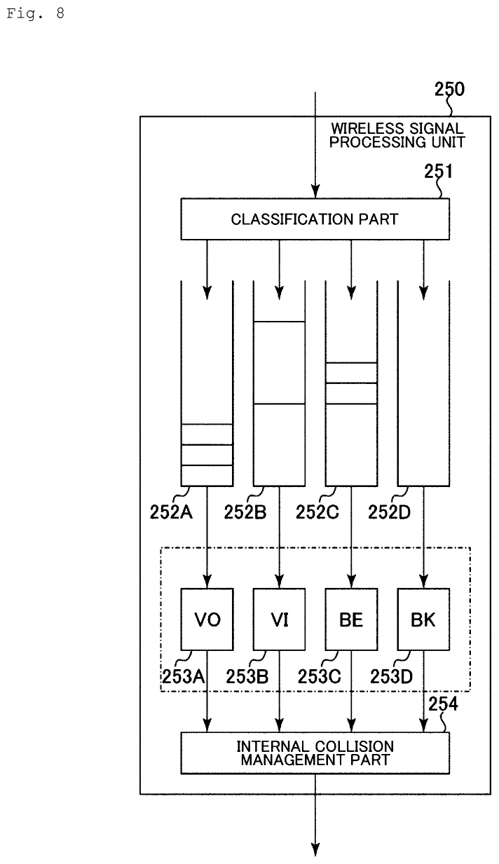

FIG. 8 is a block diagram showing an example of a functional configuration relating to transmission determination processing of the terminal according to the embodiment. FIG. 8 shows the functional configuration of the wireless signal processing unit 250 as a functional configuration relating to transmission determination processing of the terminal. On the other hand, the functional configuration relating to the transmission determination processing of the AP is also equivalent to the functional configuration shown in FIG. 8.

The wireless signal processing unit 250 includes a classification part 251, a plurality of queues 252A, 252B, 252C, and 252D, a plurality of carrier sensing parts 253A, 253B, 253C, and 253D, and an internal collision management part 254.

When the MAC frame input from the MAC frame processing unit 240 is a data frame, the classification part 251 classifies the data frame into a plurality of access categories on the basis of a traffic indicator (TID) included in the MAC header. The TID is an identifier indicating traffic and can be associated with an access category. Traffic access categories include, for example, “voice (VO),” “video (VI),” “best effort (BE),” and “background (BK).” The classification part 251 inputs the data frame into a corresponding one of the plurality of queues 252A, 252B, 252C, and 252D. In the example of FIG. 8, the classification part 251 inputs data frames corresponding to access categories VO, VI, BE, and BK to queues 252A, 252B, 252C, and 252D, respectively.

Each of the plurality of queues 252A, 252B, 252C, and 252D buffers input data frames. In the example of FIG. 8, the plurality of queues 252A, 252B, 252C, and 252D buffer data frames corresponding to access categories VO, VI, BE, and BK, respectively.

The plurality of carrier sensing parts 253A, 253B, 253C, and 253D correspond to the plurality of queues 252A, 252B, 252C, and 252D, respectively. Each of the plurality of carrier sensing parts 253A, 253B, 253C, and 253D performs carrier sensing processing based on carrier sense multiple access with collision avoidance (CSMA/CA) according to preset access parameters. When it is determined that the channel is in an idle state for a predetermined period of time, each of the plurality of carrier sensing parts 253A, 253B, 253C, and 253D acquires the right to transmit a data frame and ends the carrier sensing processing. When it is determined that the channel is in a busy state, each of the plurality of carrier sensing parts 253A, 253B, 253C, and 253D stops acquiring the transmission right and ends the carrier sensing processing.

As access parameters used in carrier sensing processing, for example, CWmin, CWmax, an arbitration inter frame space (AIFS), and a transmission opportunity (TXOP) Limit are used. CWmin and CWmax indicate the minimum and maximum contention window values, respectively. The contention window is a parameter which indicates the time range within which random backoff for collision avoidance is determined. The ATFS is a fixed transmission waiting time set for each access category. The TXOPLimit indicates an upper limit of the channel occupation period TXOP. That is to say, the shorter CWmin, CWmax, and AIFS are set the access category, the easier it is to acquire the transmission right. Furthermore, the larger the TXOPLimit is set for the access category, the larger the amount of data which can be transmitted with one transmission right.

The internal collision management part 254 prevents transmission collision when two or more carrier sensing parts acquire transmission rights at the same time. Specifically, for example, when a plurality of data frames are input at the same time, the internal collision management part 254 preferentially transmits a data frame of an access category with a high priority.

### 2. Operation

An operation of the r-TWT function in the communication system according to the embodiment will be explained below.

### 2.1 AP Operation

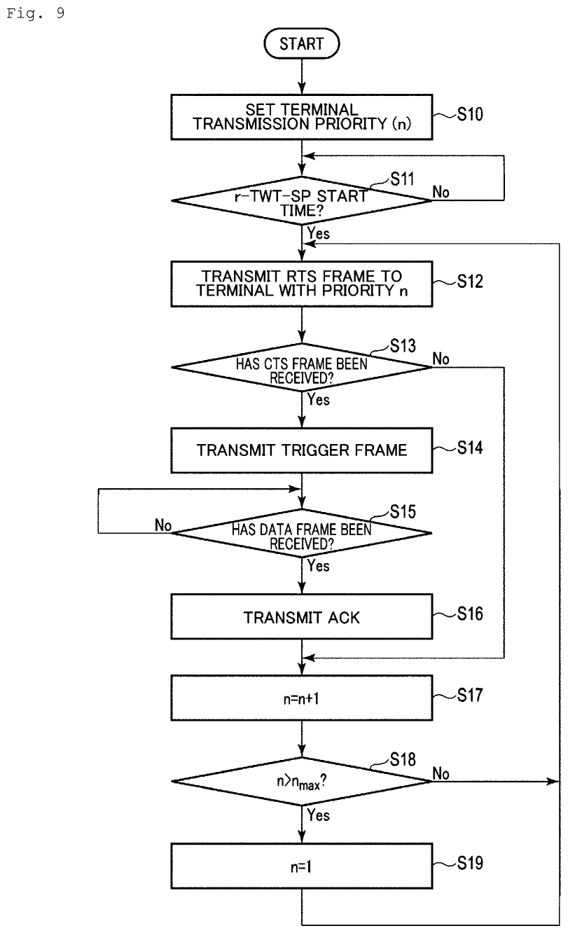

FIG. 9 is a flowchart for describing an example of an operation of an AP according to the embodiment. Here, FIG. 9 basically shows an operation during the service period r-TWT-SP. An r-TWT setup operation is performed before the start of the service period r-TWT-SP. The setup operation will be briefly explained.

In the setup operation, the beacon management part 131 of the AP 10 generates a beacon frame. The beacon frame includes, for example, an r-TWT-SP start time and an r-TWT-SP duration. The beacon frame may further include a transmission suppression period. After generating the beacon frame, the beacon management part 131 inputs the beacon frame to the MAC frame processing unit 140. The MAC frame processing unit 140 inputs the beacon frame to the wireless signal processing unit 150. The wireless signal processing unit 150 generates a beacon signal from the beacon frame and radiates (transmits) the beacon signal from the antenna. Here, the beacon signal is periodically transmitted at a predetermined cycle also after Step S10. When the service period r-TWT-SP needs to be set at a constant cycle, the beacon signal transmission cycle may be determined in accordance with the service period r-TWT-SP.

When the beacon management part 231 of the terminal 20 receives a beacon frame via the MAC frame processing unit 240, the beacon management part 231 extracts management information relating to the r-TWT function from the beacon frame and retains the extracted management information to perform setting relating to the service period. Thus, the terminal 20 supporting the r-TWT function can recognize the service period r-TWT-SP.

In Step S10 that is a timing before the start of the service period r-TWT-SP, the transmission timing processing part 133 sets the priority n of each of the terminals 20. A priority n is, for example, a natural number, and the closer it is to 1, the higher the priority. Furthermore, an initial value of the priority n is 1. As described above, the assignment of the priority n may be determined in accordance with the priority of traffic to be exchanged by each of the terminals 20. Information regarding traffic to be exchanged by each of the terminals 20 may be set in advance in the transmission timing processing part 133 of the AP 10, or may be, for example, collected from each of the terminals 20 at the timing of a setup operation.

In Step S11, the transmission timing processing part 133 determines whether the current time has reached the r-TWT-SP start time. In Step S11, when it is determined that the current time has not reached the r-TWT-SP start time, the process is put on standby. While processing is waiting, the AP 10 may perform an exchange of data frames with the terminal 20. In Step S11, when it is determined that the current time has reached the r-TWT-SP start time, the transmission timing processing part 133 notifies the trigger management part 132 that the current time has reached the r-TWT-SP start time. After that, the process proceeds to Step S12.

In Step S12, the trigger management part 132 performs processing to transmit an RTS frame addressed to the terminal 20 with the priority n. Specifically, the trigger management part 132 generates an RTS frame. The RTS frame in the embodiment includes a Duration field in which the period from the transmission of the RTS signal to the scheduled time of completion of transmission of the trigger frame is stored. Furthermore, the RTS frame in the embodiment includes an RA field in which the MAC address of the terminal 20 with the priority n is stored. The scheduled time from when the RTS signal is transmitted until the transmission of the trigger frame is completed is determined based on the time required to exchange the RTS frame, the time required to exchange the CTS frame, the time required to exchange the trigger frame and the delay status collected from each of the terminals 20. After generating the RTS frame, the trigger management part 132 inputs the RTS frame to the MAC frame processing unit 140. The MAC frame processing unit 140 inputs the RTS frame to the wireless signal processing unit 150. The wireless signal processing unit 150 generates an RTS signal from the RTS frame and radiates (transmits) the RTS signal from the antenna. Here, in the embodiment, it is preferable that the RTS frames be exchanged in a short time. Therefore, RTS frames may be transmitted using the highest priority access category of EDCA. Alternatively, the RTS frame may be transmitted using a frame exchange procedure in which exchange is completed earlier than a frame exchange procedure using EDCA. For example, a frame exchange procedure may be adopted which waits for the short inter frame space (SIFS) or the distributed inter frame space (DIFS) time without carrier sensing, and then transmits an RTS signal without waiting for the random backoff time.

In Step S13, the trigger management part 132 determines whether a CTS frame has been received from the terminal 20 with the priority n during a predetermined period of time. A certain period may be a fixed period, such as SIFS or DIFS. When it is determined in Step S13 that a CTS frame has been received from the terminal 20 with the priority n during a predetermined period of time, the process proceeds to Step S14. When it is determined in Step S13 that the CTS frame has not been received from the terminal 20 with the priority n during a predetermined period of time, the process proceeds to Step S17.

In Step S14, the trigger management part 132 performs processing for transmitting a trigger frame to the terminal 20 with the priority n. After that, the process proceeds to Step S15. Specifically, the trigger management part 132 generates a trigger frame. The trigger frame in an embodiment includes a User Info List field. The AID 12 subfield of the User Info List stores the AID of the terminal 20 with the priority n. Furthermore, the RU subfield of the User Info List stores information on resources allocated to the terminal 20 with the priority n. After generating the trigger frame, the trigger management part 132 inputs the trigger frame to the MAC frame processing unit 140. The MAC frame processing unit 140 inputs the trigger frame to the wireless signal processing unit 150. The wireless signal processing unit 150 generates a trigger signal from the trigger frame and radiates (transmits) the trigger signal from the antenna. Here, in the embodiment, it is preferable that the trigger frame as well as the RTS frame be exchanged in a short time. Therefore, the trigger frame may also be transmitted using the highest priority access category of EDCA. Alternatively, the trigger frame may also be transmitted using a frame exchange procedure in which exchange is completed earlier than a frame exchange procedure using EDCA.

In Step S15, the management unit 130 determines whether a data frame has been received from the terminal 20. For example, in Step S15, the management unit 130 inquires of, for example, the MAC frame processing unit 140 whether a data frame has been received from the wireless signal processing unit 150. In Step S15, the process waits until it is determined that a data frame has been received from the terminal 20. When it is determined in Step S15 that a data frame has been received from the terminal 20, the process proceeds to Step S16.

In Step S16, the management unit 130 performs processing for transmitting an acknowledgment (ACK). After that, the process proceeds to Step S17. In Step S16, the management unit 130 generates an ACK and inputs it to the MAC frame processing unit 140. The MAC frame processing unit 140 inputs the ACK to the wireless signal processing unit 150. The wireless signal processing unit 150 radiates (transmits) the ACK from the antenna. Here, the ACK may be generated as a block ACK.

In Step S17, the transmission timing processing part 133 adds 1 to the value of priority n.

In Step S18, the transmission timing processing part 133 determines whether the value of priority n exceeds nₘₐₓ. nₘₐₓ is the number of terminals 20 for which priority is set. When it is determined in Step S18 that the priority value does not exceed nₘₐₓ, the process returns to Step S12. In this case, the RTS frame is transmitted to the terminal 20 with the next priority. When it is determined in Step S18 that the value of priority n exceeds nₘₐₓ, the process proceeds to Step S19.

In Step S19, the transmission timing processing part 133 returns the value of priority n to the initial value of 1. After that, the process returns to Step S12. After that, the processes of Steps S12 to S19 are repeatedly performed until the service period r-TWT-SP ends.

### 2.2 Terminal Operation

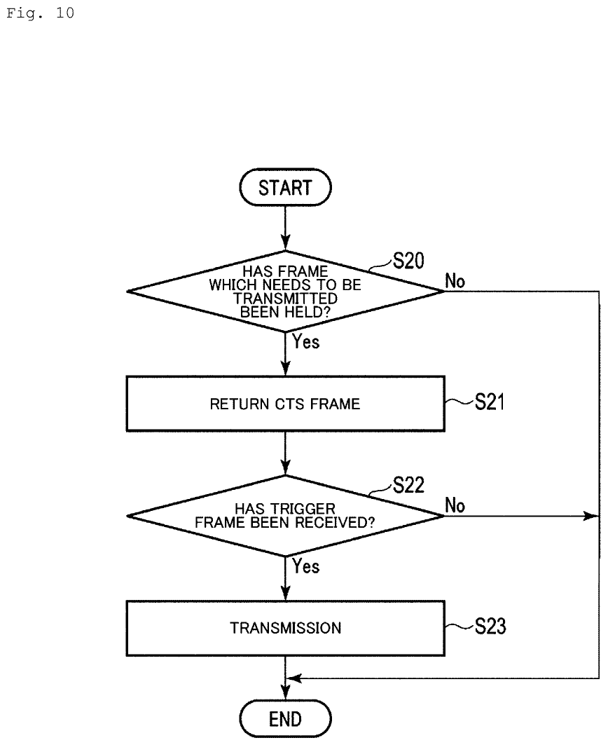

FIG. 10 is a flowchart for describing an operation of the terminal. Here, FIG. 10 shows an operation of the terminal 20 during the service period r-TWT-SP. The process in FIG. 10 starts when the terminal 20 receives an RTS frame.

In Step S20, the management part 230 determines whether it holds a data frame scheduled to be transmitted during the service period r-TWT-SP. For example, in Step S20, the management part 230 inquires of, for example, the MAC frame processing unit 240 whether there is a data frame scheduled to be transmitted during the service period r-TWT-SP. When it is determined in Step S20 that a data frame scheduled to be transmitted is held, the process proceeds to Step S21. When it is determined in Step S20 that the data frame scheduled to be transmitted is not held, the process in FIG. 10 ends. In this case, the process of Step S21 is not performed and the CTS frame is not transmitted from the terminal 20 to the AP 10.

In Step S21, the management part 230 performs processing for transmitting a CTS frame. Specifically, the management part 230 generates a CTS frame. The CTS frame in the embodiment includes a Duration field in which a period from the transmission of the CTS signal to the scheduled completion time of transmission of the trigger frame is stored. Furthermore, the CTS frame in the embodiment includes an RA field in which the MAC address of the AP 10 is stored. The estimated transmission completion time of the trigger frame from the transmission of the CTS signal is acquired from the information stored in the Duration field of the RTS frame. After generating the CTS frame, the management part 230 inputs the CTS frame to the MAC frame processing unit 240. The MAC frame processing unit 240 inputs the CTS frame to the wireless signal processing unit 250. The wireless signal processing unit 250 generates a CTS signal from the CTS frame and radiates (transmits) the CTS signal from the antenna. Here, in the embodiment, it is preferable that the CTS frames be also exchanged in a short time. Therefore, the CTS frame may be transmitted using the highest priority access category of EDCA. Alternatively, the CTS frame may be transmitted using a frame exchange procedure in which exchange is completed earlier than a frame exchange procedure using EDCA.

In Step S22, the management part 230 determines whether or not a trigger frame addressed to its own station from the AP 10 has been received during a predetermined period of time. A certain period may be a fixed period such as SIFS or DIFS. Furthermore, a determination concerning whether the trigger frame is addressed to its own station can be determined from the AID stored in the AID 12 subfield of the User Info List frame. In Step S22, when it is determined that a trigger frame addressed to its own station has been received from the AP 10 during a predetermined period of time, the process proceeds to Step S23. In Step S22, when it is determined that the trigger frame addressed to its own station from the AP 10 has not been received within a predetermined period of time, the process in FIG. 10 ends.

In Step S23, the MAC frame processing unit 240 inputs a data frame to be exchanged with the AP 10, for example, a low-latency traffic data frame, to the wireless signal processing unit 250. The wireless signal processing unit 250 transmits a wireless signal using the access category with the highest priority of EDCA or using a frame exchange procedure in which exchange is completed earlier than a frame exchange procedure using EDCA. After that, the process in FIG. 10 ends.

2.3 Operation Example During Service Period r-TWT-SP

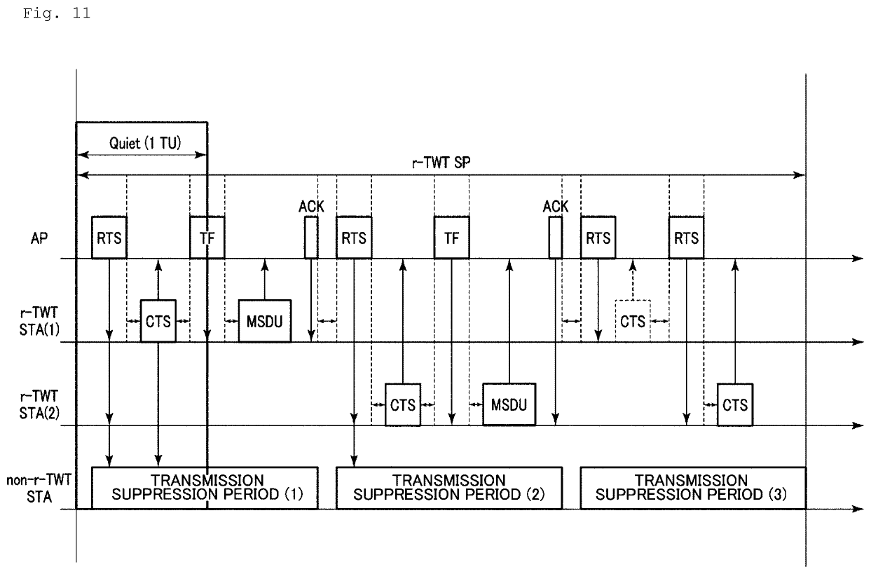

FIG. 11 is a diagram showing an example of an operation during the service period r-TWT-SP using the system according to the embodiment. In FIG. 11, an example of three terminals under the AP is shown. Two of the terminals are terminals r-TWT STA(1) and r-TWT STA(2) which support the r-TWT function. The other terminal is a terminal non-r-TWT STA which does not support the r-TWT function. Here, the priority n is set for the terminals r-TWT STA(1) and r-TWT STA(2). The priority of the terminal r-TWT STA(1) is higher than the priority of the terminal r-TWT STA(2). Furthermore, in FIG. 11, a transmission suppression period Quiet is set. A time length of the transmission suppression period Quiet is 1 TU.

As shown in FIG. 11, first, an RTS frame addressed to the highest priority terminal r-TWT STA(1) is transmitted from the AP in time with the r-TWT-SP start time. When the terminal r-TWT STA(1) holds a data frame, it transmits a CTS frame to the AP immediately after receiving the RTS frame, for example after SIFS has elapsed.

The RTS frame is also received by the terminal r-TWT STA(2) and the terminal non-r-TWT STA. However, since the RTS frames received by the terminal r-TWT STA (2) and the terminal non-r-TWT STA are not RTS frames addressed to its own station, the terminal r-TWT STA (2) and the terminal non-r-TWT STA sets a network allocation vector (NAV) according to the Duration field. The Duration field of the RTS frame stores the value of the period from the transmission of the RTS signal to the scheduled completion time of transmission of the trigger frame. Therefore, for the terminal r-TWT STA(2) and the terminal non-r-TWT STA, the transmission of wireless signals is suppressed from the transmission of the RTS signal until the scheduled completion time of transmission of the trigger frame.

The AP transmits a trigger frame to the terminal r-TWT STA(1) immediately after receiving the CTS frame from the terminal r-TWT STA(1), for example after SIFS has elapsed. Also, the AP then waits for the data frame to be transmitted from the terminal r-TWT STA(1). Here, the trigger frame is also received by the terminal r-TWT STA(2) and the terminal non-r-TWT STA. However, since the RTS frames received by the terminal r-TWT STA(2) and the terminal non-r-TWT STA are not trigger frames addressed to its own station, the terminal r-TWT STA(2) and the terminal non-r-TWT STA sets an NAV according to the Duration field.

When the terminal r-TWT STA(1) receives a trigger frame, it transmits a wireless signal including a data frame MAC service data unit (MSDU) in accordance with the resources allocated using the trigger frame. For example, if the value of SIFS is set as the transmission start timing, the terminal r-TWT STA(1) transmits the wireless signal after the SIFS has elapsed. The wireless signal is received at the AP and an acknowledgment (ACK) is returned from the AP. During the transmission of such a data frame, the channel is occupied by the terminal r-TWT STA(1). Thus, the terminal r-TWT STA(2) and the terminal non-r-TWT STA cannot acquire the transmission right. For this reason, from the time the AP transmits the RTS frame until the end of the terminal r-TWT STA(1)'s data frame transmission and the ACK is returned from the AP, terminal r-TWT STA(2) and terminal non-r-TWT STA's wireless signal transmission is suppressed. In FIG. 11, this period is shown as a transmission suppression period (1).

The AP transmits an RTS frame addressed to the terminal r-TWT STA(2) immediately after transmitting the ACK, for example after the DIFS has elapsed. When the terminal r-TWT STA(2) holds a data frame, it transmits a CTS frame to the AP immediately after receiving the RTS frame, for example after SIFS has elapsed.

The RTS frame is also received by the terminal r-TWT STA(1) and the terminal non-r-TWT STA. However, since the RTS frames received by the terminal r-TWT STA(1) and the terminal non-r-TWT STA are not RTS frames addressed to its own station, the terminal r-TWT STA(1) and the terminal non-r-TWT STA sets an NAV according to the Duration field.

The AP transmits a trigger frame to the terminal r-TWT STA(2) immediately after receiving the CTS frame from the terminal r-TWT STA(2). Also, the AP waits for the data frame to be transmitted from the terminal r-TWT STA(2). Here, the trigger frame is also received by the terminal r-TWT STA(1) and the terminal non-r-TWT STA. However, since the RTS frames received by the terminal r-TWT STA(1) and the terminal non-r-TWT STA are not trigger frames addressed to its own station, the terminal r-TWT STA(1) and the terminal non-r-TWT STA sets an NAV according to the Duration field.

When the terminal r-TWT STA(2) receives a trigger frame, it transmits a wireless signal including a data frame MSDU in accordance with the resources allocated using the trigger frame. The wireless signal is received at the AP and an ACK is returned from the AP. During the transmission of such a data frame, the channel is occupied by the terminal r-TWT STA(2). Thus, the terminal r-TWT STA(1) and the terminal non-r-TWT STA cannot acquire the transmission right. For this reason, from the time the AP transmits the RTS frame until the data frame transmission of the terminal r-TWT STA(2) is completed and the ACK is returned from the AP, the terminal r-TWT STA(1) and the terminal non-r-TWT STA's wireless signal transmission is suppressed. In FIG. 11, this period is shown as a transmission suppression period (2).

Immediately after transmitting the ACK, the AP retransmits an RTS frame addressed to the terminal r-TWT STA(1). In the example of FIG. 11, the terminal r-TWT STA(1) does not hold a data frame. Thus, it does not transmit a CTS frame to the AP. In this case, the AP transmits an RTS frame addressed to the terminal r-TWT STA(2). In the example of FIG. 11, the terminal r-TWT STA(2) still holds the data frame. Thus, it transmits the CTS frame to the AP. During this period, transmission of wireless signals using the terminal non-r-TWT STA is suppressed. In FIG. 11, this period is shown as a transmission suppression period (3).

### 3. Effects Relating to Embodiments

A terminal which does not support the r-TWT function cannot recognize the r-TWT-SP start time and r-TWT-SP duration as r-TWT management information or even when it recognizes it, ignores it. Therefore, a terminal which does not support the r-TWT function will attempt to exchange data frames even when the service period is set using the AP. Thus, this will affect the exchange of low-latency traffic during the service period.

According to the embodiment, RTS frames are transmitted to terminals in order of priority, and in response to the RTS frame, a trigger frame for granting transmission rights to the terminal that has transmitted the CTS frame is transmitted. Here, the RTS frame is transmitted in accordance with the priority immediately after the start of the service period r-TWT-SP and immediately after the exchange of data frames. Thus, low-latency traffic exchange during the service period is performed preferentially. Therefore, each transmission opportunity supporting the r-TWT function is secured.

In this way, according to the embodiment, even when there is a terminal that does not support the r-TWT function, it is possible to provide a wireless communication environment in which low-latency traffic can be exchanged preferentially.

### 4. Modification Examples and Like

Note that the above-described embodiment can be modified in various ways. For example, in the embodiment described above, communication between the AP and the terminal is said to be so-called single link communication, in which communication is performed using one channel. On the other hand, in recent years, multilink communication which performs communication using two or more channels has been studied. Embodiments may also be applied in the case of multi-link communication. In the case of multi-link communication, the service period r-TWT-SP is set for each link. Also, the RTS frame, the CTS frame, and the trigger frame are transmitted for each link. The operation of the AP and the terminal for each link is the same as in the embodiment described above.

Furthermore, in the embodiment described above, after the transmission of the data frame from the terminal with the priority n is completed, the AP transmits the RTS frame to the terminal with the next priority. On the other hand, after the transmission of the data frame from the terminal with the priority n is completed, the AP may transmit the RTS frame to the same terminal again. Furthermore, when the CTS frame is not received as a result of transmitting the RTS frame to the same terminal, the RTS frame may be transmitted to the terminal with the next priority.

Furthermore, in the embodiment described above, when n exceeds nₘₐₓ, n returns to the initial value. On the other hand, if n exceeds nₘₐₓ, the process may end at that point.

Furthermore, the transmission determination processing according to the embodiment and the modification example described above can be stored as a program which can be executed by a processor that is a computer. In addition, it can be stored and distributed in a storage medium of an external storage device such as a magnetic disk, an optical disc, or a semiconductor memory. Also, the processor reads the program stored in the storage medium of the external storage device and an operation thereof is controlled using the read program, whereby the transmission determination processing is able to be performed.

Note that the present invention is not limited to the above-described embodiments and can be variously modified at the implementation stage without departing from the gist thereof. Moreover, each embodiment may be implemented in combination as appropriate, and in that case, the combined effect can be obtained. Furthermore, the embodiments described above include various inventions and various inventions can be extracted by combinations selected from the plurality of constituent features disclosed. For example, if a problem can be solved and an effect can be obtained even when some constituent features are deleted from all the constituent features shown in the embodiment, the configuration from which these constituent features are deleted can be extracted as an invention.

### REFERENCE SIGNS LIST

1 Communication system
10 Access point (AP)
20 Terminal
30 Network
11, 21 CPU
12, 22 ROM
13, 23 RAM
14, 24 Wireless communication module
15 Wired communication module
25 Display
26 Storage
200 Application execution unit
110, 210 LLC processing unit
130, 230 Management unit
131, 231 Beacon Management part
132 Trigger management part
133 Transmission timing processing part
140, 240 MAC frame processing unit
150, 250 Wireless signal processing unit
251 Classification part
252A, 252B, 252C, 252D Queue
253A, 253B, 253C, 253D Carrier sensing part
254 Internal collision management part

1. An access point, comprising a processor with hardware configured to:
transmit an RTS signal including an RTS frame to a terminal immediately after start of a service period or immediately after exchanging data frames performed during the service period, and
transmit a trigger signal including a trigger frame to a terminal which has received the RTS frame immediately after receiving the CTS frame from the terminal which has received the RTS frame.

2. The access point according to claim 1, wherein immediately after the start of the service period or the exchange of data frames performed during the service period is after a short inter frame space (SIFS) period or a distributor inter frame space (DIFS) period has elapsed.

3. The access point according to claim 1, the processor further configured to:
set priority of the terminals which exchange data frames during the service period and sets a transmission order of the RTS signals in order according to the priority; and
generate the RTS frame addressed to each of the terminals in accordance with the transmission order.

4. The access point according to claim 1, wherein the data frame is a data frame which requires low latency.
